(19) United States
(12) Patent Application Publication
(10) Pub. No.: US 2024/0375130 A1
(43) Pub. Date: Nov. 14, 2024

(54) ATOMIZER NOZZLE

(71) Applicant: BASF SE, Ludwigshafen Am Rhein (DE)

(72) Inventors: Onur TURGUT, Ludwigshafen (DE); Martin SCHLICHER, Ludwigshafen (DE); Marco GROSS, Ludwigshafen (DE)

(21) Appl. No.: 18/690,761

(22) PCT Filed: Oct. 4, 2022
(86) PCT No.: PCT/EP22/77536

§ 371 Date: Mar. 11, 2024

(30) Foreign Application Priority Data
Oct. 11, 2021 (EP) 21201968.1

(51) Int. Cl. B05B 7/06; B05B 7/10

(52) U.S. Cl. CPC B05B 7/066; B05B 7/10

(57) ABSTRACT

Described herein is an atomizer nozzle for atomizing a first fluid by means of a second fluid, including a nozzle body and a nozzle head. The nozzle head is designed as a sleeve-shaped cap attached to a part of the outer surface of the nozzle body, and the outer flow channel includes two sections, a first section extending completely in the nozzle body, and a second section being formed by the outer surface of the nozzle body and the inner surface of the nozzle head.

The invention relates to an atomizer nozzle for atomizing a first fluid by means of a second fluid comprising a nozzle body and a nozzle head, the atomizer nozzle having an inner flow channel arranged in the nozzle body and having an inlet and an outlet for the first fluid to be atomized, and an outer flow channel arranged around the inner flow channel and having an inlet and an outlet for the second fluid.

Atomizer nozzles, also named “spray nozzles”, are known in the art for different purposes, for example for the dispersion of liquids into a spray. Besides single-fluid nozzles, where the kinetic energy of the liquid is used to break up the liquid into droplets, two-fluid nozzles are established means for atomizing a liquid stream via a second stream. Typically, a high-velocity flow of gas or vapor is contacted with a liquid flow. Due to the kinetic energy of the gaseous or vaporous flow the fluid flow is atomized into particles.

Despite the variety of designs, two-fluid nozzles can be divided in two groups: internal mix nozzles and external mix nozzles. Internal mix nozzles contact the fluids inside the nozzle such that a jet of atomized particles leaves the nozzle outlet. External mix nozzles contact the fluids outside the nozzle such that atomization takes place after the fluids have left the nozzle outlet. Both types of nozzles have their advantages and disadvantages.

Two-fluid nozzles can be used in a variety of different applications. One application where the design of the nozzle is of utmost importance is waste incineration, in particular hazardous waste incineration. Typically, such waste incineration facilities comprise a rotary kiln and a secondary combustion chamber that are covered with refractory bricks on the inside to withstand the high incineration temperature. In the incineration plants, gas, solid and fluid wastes with different viscosities are incinerated. Hazardous low viscosity fluid wastes are brought into the rotating kiln and the post burning chamber through pipelines and atomized by nozzles inserted on lances for incineration. Especially at high throughput rates of waste in the secondary combustion chamber, typically 750 liter per hour waste or more, the flame length increases extremely, and the sprayed waste/flame mixture starts to hit the refractory on the opposite side of lances. In such case, the refractory is being overstrained through direct flame on the surface and waste burning on the refractory surface. This causes a premature damage in the refractory, leading an unplanned standstill and therefore availability loss. Thus, for use in a waste incineration plant, an atomizer nozzle which facilitates a short flame length and a broad flame width would be beneficial. Furthermore, the nozzle should be adaptable to different types of wastes, especially in terms of composition and flow properties like viscosity.

The document US 2017/0348721 A1 discloses a multiphase injection nozzle of the external mix type that is suitable for use in a high-temperature process environment. The nozzle comprises a plurality of passageways in the nozzle with a primary passageway and at least one secondary passageway. The passageways are operable to simultaneously inject respective process media into a reactor at different angles relative to each other. The nozzle is designed to offset the flame from the nozzle tip, i.e. its outlet. Adjustment of the spray pattern for different product properties is only possible to a limited extent via the quantities and speeds of the supplied streams.

The document DE 100 45 320 A1 discloses a similar external mix nozzle for use as a burner nozzle, e.g. for the regeneration of sulfur-containing residual material. To prevent corrosion at the nozzle tip due to the aggressive sulfur, the nozzle comprises an inner channel for the residual to be burned, an outer channel for an oxygen-rich gas stream and an intermediate channel between the inner and the outer channel for the provision of a shielding gas. A contact of sulfur and oxygen at the nozzle outlet is prevented which leads to a longer lifetime of the nozzle. The nozzle was developed for a special fuel composition such that an adjustment of the spray pattern for different product properties is only possible to a limited extent via the quantities and speeds of the supplied streams.

The document US 2005/0026099 A1 discloses a burner nozzle of the external mix type formed of generally concentric inner and outer pieces. The inner piece defines a fuel conduit, and the outer piece defines an annular gas conduit which tapers down towards the outlet end of the nozzle and has a rounded edge near the outlet end. The inner piece is longitudinally translatable, within a limited range of movement, relative to the outer piece, and can be locked into a desired position. According to the disclosure, the nozzle promotes efficient mixing of fuel and air outside the burner. The stream of air creates a partial vacuum in the vicinity of the outlet end, serving to draw fuel out of the fuel conduit. Even though the length of the flame is adjustable via the longitudinal translation of the inner piece in relation to the outer piece, the width of the flame is not adjustable.

External mix type nozzles are also known for applications other than burners. For example, document WO 2007/006861 A1 discloses a moistening nozzle of a paper web comprising a frame into which air and water are fed. Inside the frame a water nozzle is arranged wherewith water is conducted to an outlet of the moistening nozzle and an air nozzle wherewith air is correspondingly conducted to the outlet. The air nozzle and the water nozzle are arranged one within the other such that the air and the water form water mist that is sprayed out from the moistening nozzle.

The document U.S. Pat. No. 3,844,484 A discloses a fuel atomizer nozzle of the internal mix type that produces very fine fuel particle sizes, e.g. for use in boilers, gas turbines and the like. An inner liquid fuel stream hits an outer gas stream at an angle of about 90° before the nozzle outlet. The fuel is jetted with a whirling motion in an axial direction away from the atomizer, and the gas is whirled inwardly at right angles to its whirling axis or axially either in the same direction as or in the opposite direction as the axial direction of movement for the fuel. As a result, the atomization is fine and the spray pattern is wide. However, the nozzle is not adjustable for different products. The nozzle is designed for very pure fuels. Due to the small passages and the rectangular deflections in the inner channel for the fuel stream, any solid particles contained in the fuel would lead to a blocking of the small channels. Thus, a nozzle of that design is not usable in hazardous waste incineration where solid particles or particles with a high viscosity may be present in the liquid stream to be atomized.

Even though there are atomizer nozzles available that are suitable for some kinds of applications, there is still a need for multi-purpose nozzles that are adjustable in view of different substances to be atomized and in view of their spray pattern and the resulting form of the flame.

It was an object of the invention to provide an atomizer nozzle applicable to waste incineration plants, that facilitates a short but broad flame and that is robust against clogging by the waste to be incinerated. It was a further object of the invention to provide an atomizer nozzle that is adaptable to different kinds of waste to be incinerated, especially in terms of composition and flow properties like viscosity.

This object is achieved according to the invention by an atomizer nozzle according to claim 1, a waste incineration plant according to claim 13 and a method according to claim 14. Advantageous variants of the atomizer nozzle are presented in claims 2 to 12.

A first subject of the invention is an atomizer nozzle for atomizing a first fluid by means of a second fluid comprising a nozzle body and a nozzle head. The atomizer nozzle has an inner flow channel arranged in the nozzle body and has an inlet and an outlet for the first fluid to be atomized. An outer flow channel is arranged around the inner flow channel and has an inlet and an outlet for the second fluid. The outlet of the inner flow channel ends before the outlet of the outer flow channel in the direction of flow, the outer flow channel at its outlet being inclined towards the inner flow channel. The nozzle head has a nozzle outlet for the atomized fluid and is placed on the outlet-side end of the nozzle body and partially surrounds it in the radial and in the axial direction, the cross-sectional area of the outlet of the inner flow channel being smaller than the cross-sectional area of the nozzle outlet. The nozzle head is designed as a sleeve-shaped cap attached to a part of the outer surface of the nozzle body, and the outer flow channel comprises two sections, a first section extending completely in the nozzle body, and a second section being formed by the outer surface of the nozzle body and the inner surface of the nozzle head.

A second subject of the invention is a waste incineration plant comprising at least one atomizer nozzle according to the invention for the incineration of waste.

The nozzle head partially surrounds the nozzle body in the radial and in the axial direction. In combination with the inclined end of the outer flow channel this leads to a mixing behavior between the external mix type and the internal mix type. The second fluid flowing out of the outer channel is directed towards the inner channel and hits the first fluid shortly before the nozzle outlet. In particular for applications in waste incineration where the first fluid may have varying viscosity or polymerization properties and may even contain small solid particles, mixing the two fluids shortly before the exit of the nozzle has the advantage that fouling or clogging of inner parts of the nozzle is prevented.

Even more important, the spray pattern of the nozzle is short and broad which renders it useful for waste incinerations processes. Advantages are an increase in availability of the facility by eliminating a premature refractory damage caused by flame and waste droplets hitting the refractory of the combustion chamber, a longer nozzle service time through improved damping and distribution of vibration forces over the outer shell integrated to the geometry, and less assembly effort of the nozzle due to a monolithic design.

A further advantage of the atomizer nozzle according to the invention is that due to the design of nozzle body and nozzle head as two separate parts, the channel width at the outlet of the outer flow channel shortly before the nozzle outlet can be selected and adjusted to the needs of the respective application.

In a preferred embodiment of the atomizer nozzle the outer flow channel comprises baffles extending in axial direction over at least a partial area of the outer flow channel and in radial direction from the inner wall to the outer wall of the outer flow channel. An advantage of this embodiment is the stabilization of the nozzle body against radial pressure and thus a higher robustness and longer lifetime of the atomizer nozzle.

The baffles can have any suitable shape or form provided that the open flow area for the second fluid in the outer channel is sufficiently large for the respective purpose. Preferably, the baffles are helically shaped in the direction of flow so that they form a swirl region in the outer flow channel. Baffles according to this embodiment induce a swirl or vortex of the second fluid in the outer channel which can result in a beneficial mixing behavior for certain applications.

Preferably, the inclination of the baffles decreases with respect to the flow direction from the inlet towards the outlet.

The baffles can be manufactured separately from the nozzle body or in connection with the nozzle body. In case of separate manufacturing, the baffles can for example be prefabricated as inserts that are inserted into the outer flow channel and fixed therein.

In a preferred embodiment the baffles are integrally connected to the inner wall and the outer wall of the outer flow channel. More preferably the baffles are manufactured with the nozzle body, for example by an additive manufacturing method. Integrally connected baffles are advantageous as they provide a stable connection to the channel walls and stabilize the nozzle body in a particular manner.

It is preferred that a multitude of baffles is provided in the outer flow channel and is uniformly distributed in the circumferential direction. This ensures an even load distribution and stabilization in the circumferential direction. Preferably, at least four baffles are present which are uniformly distributed in the circumferential direction.

According to the invention the outer flow channel at its outlet is inclined towards the inner flow channel. In a preferred embodiment, the inclination is such that the tangent to the inner surface of the nozzle head and the plane of the nozzle outlet form an outlet angle of 100° to 180°, more preferably an outlet angle of 145° to 175°. Depending on the geometric design of the nozzle outlet, for example the distance of the outlet of the inner flow channel to the outlet of the outer flow channel and to the nozzle outlet, the inclination can be adjusted such that the two stream mix in an optimal way shortly before the nozzle outlet.

In a preferred embodiment of the atomizer nozzle the cross-sectional area of the outer flow channel decreases in the direction of flow.

It is further preferred that the cross-sectional areas of the inner flow channel and of the outer flow channel are rotationally symmetrical. An atomizer nozzle according to this embodiment can be easily used in any position in an apparatus, for example in a chamber of an incineration plant, without having to pay attention to its installation position.

In a particularly preferred embodiment, the cross-sectional area of the inner flow channel is circular and the cross-sectional area of the outer flow channel is a circular ring.

The inner flow channel can have any form and dimension that is suitable for flowing the first fluid through the inner flow channel. Preferably, the inner flow channel has the form of a cylinder, more preferably with a circular cross-section. The diameter of the inner flow channel is preferably from 8 mm to 15 mm, more preferably from 10 mm to 12 mm. In a favorable embodiment the inner flow channel widens conically towards the end, the cone angle being in the range from 5° to 25°.

In a preferred embodiment of the atomizer nozzle the nozzle body and the nozzle head are adjustable relative to one another in the axial direction. As the outlet of the outer flow channel is formed by the outer surface of the nozzle body and the inner surface of the nozzle head, a relative movement of the nozzle head to the nozzle body causes a change in the geometry or dimension of the outlet of the outer flow channel. Thus, by adjusting the nozzle head relative to the nozzle body the amount and velocity of flow of the second fluid can be adapted to the needs of the respective application, for example depending on physical properties of the first or second fluid like viscosities or surface tension. Furthermore, the ratio of amounts of the first fluid in the inner channel and the second fluid in the outer channel can be varied by the adjustment of the relative position of the nozzle head to the nozzle body.

The atomizer nozzle can be fabricated of any material suitable to withstand the stresses and forces the nozzle is exposed to in operation, in particular due to temperatures, pressures and physicochemical properties of the first and second fluid. In a preferred embodiment material of the atomizer nozzle is selected from the group of metallic materials, ceramic materials or combined metal-ceramic materials. More preferably, the metallic materials, ceramic materials or combined metal-ceramic materials are suited to be processed in an additive manufacturing process.

In a preferred embodiment the material for fabricating the atomizer nozzle is a metallic material selected from the group of aluminum alloys, magnesium alloys, nickel-base alloys, steel, stainless steel or tool steel. If a lightweight construction is a requirement aluminum alloys or magnesium alloys are preferred. If mechanical strength and stability are requirements tool steel is preferred. If chemical resistance of the first material is of importance stainless steel or nickel-base alloys are preferred.

Particularly in the case of a geometrically complex nozzle body, production using an additive manufacturing process is advantageous. Additive manufacturing processes, also referred to as generative manufacturing processes or 3D printing, are known from the prior art. In an additive manufacturing process, the material is added layer by layer to produce a component. In the case of metal powder or ceramic powder as a material, for example, metal powder particles or ceramic powder particles are applied iteratively and melted by energy input, so that the component is built up layer by layer. Examples of suitable additive manufacturing processes are selective laser melting (SLM), selective laser sintering (SLS), binder jetting, direct energy deposition processes such as laser metal deposition (LMD) and electron beam melting (EBM), cold spray and wire arc additive manufacturing (WAAM).

The nozzle body and the nozzle head can be manufactured in different ways. In a first preferred variant, they are completely manufactured in an additive manufacturing process. In this variant, the respective component is preferably manufactured coaxially to the longitudinal axis. The layered construction preferably begins with the inlet side of the nozzle body.

After fabrication of the nozzle body and the nozzle head they can be subjected to a thermal treatment and/or a chemical treatment to further enhance their mechanical or physicochemical properties. Thermal treatment may include homogenization or stress relief annealing. Stress relief annealing relieves residual stresses in the finished component and minimizes subsequent distortion of the component during operation. Chemical treatment may include nitriding to increase the hardness of the component.

A third subject of the invention is a method for atomizing a first fluid by means of a second fluid in an atomizer nozzle according to the invention. Preferably, the first fluid is a liquid and the second fluid is a gas.

More preferably the first fluid is a liquid that is produced as waste from a process plant, for example a chemical or pharmaceutical process plant. The first fluid may contain different organic and/or inorganic components with different densities and viscosities. The first fluid may contain solids, for example suspended solids.

It is further preferred that the second fluid is a gas stream containing nitrogen, air, steam or mixtures thereof.

In a preferred embodiment the atomizer nozzle is designed to be capable of atomizing a first fluid at a flow rate of from 200 liter/hour to 1500 liter per hour. The amount of a gaseous second fluid is preferably from 150 to 300 Nm³/h (norm cubic meters per hour).

The invention is explained in more detail below with reference to the drawings. The drawings are to be understood as principle representations. They do not represent any limitation of the invention, for example with regards to specific embodiments. In the figures:

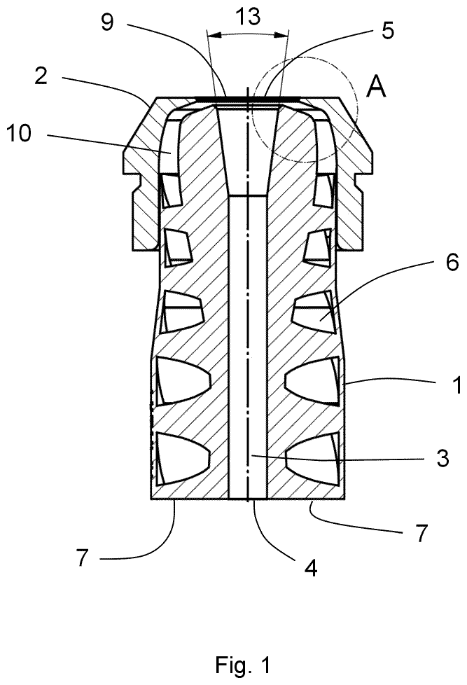

FIG. 1 shows a longitudinal section of a first embodiment of an atomizer nozzle according to the invention.

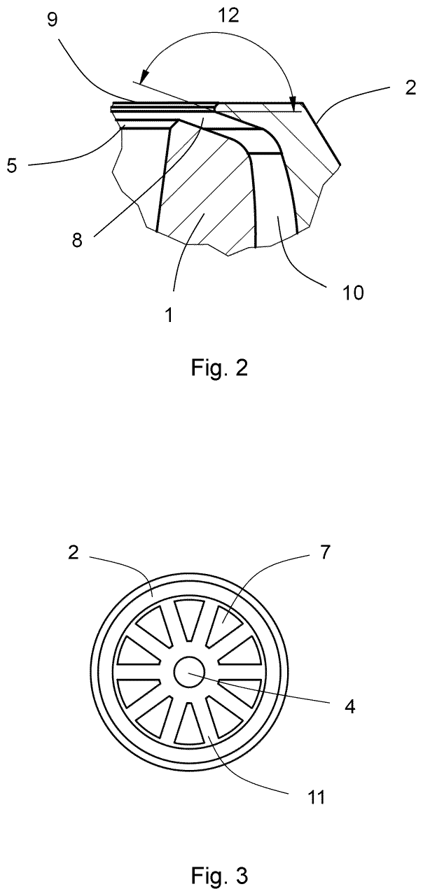

FIG. 2 shows a detailed view of the outlet area of the atomizer nozzle according to FIG. 1.

FIG. 3 shows a bottom view of the atomizer nozzle according to FIG. 1.

### LIST OF REFERENCE NUMERALS USED

1 . . . nozzle body
2 . . . nozzle head
3 . . . inner flow channel
4 . . . inlet of the inner flow channel
5 . . . outlet of the inner flow channel
6 . . . outer flow channel
7 . . . inlet of the outer flow channel
8 . . . outlet of the outer flow channel
9 . . . nozzle outlet
10 . . . second section of the outer flow channel
11 . . . baffle
12 . . . outlet angle
13 . . . cone angle

FIG. 1 shows a longitudinal section of a first embodiment of an atomizer nozzle according to the invention. FIG. 2 shows a detailed view of the outlet area of the atomizer nozzle, denoted as detail “A” in FIG. 1. FIG. 3 shows a bottom view of the atomizer nozzle.

The atomizer nozzle of this embodiment comprises a nozzle body 1 and a nozzle head 2. The atomizer nozzle has an inner flow channel 3 arranged in the nozzle body 1, the inner flow channel having an inlet 4 and an outlet 5 for a first fluid to be atomized. An outer flow channel 6 is arranged around the inner flow channel 3 and has an inlet 7 and an outlet 8 for a second fluid. The outlet 5 of the inner flow channel ends before the outlet 8 of the outer flow channel in the direction of flow, the outer flow channel 6 at its outlet 8 being inclined towards the inner flow channel 3. The nozzle head 2 has a nozzle outlet 9 for the atomized fluid and is placed on the outlet-side end of the nozzle body 1. It partially surrounds it in the radial and in the axial direction. The nozzle head 2 is designed as a sleeve-shaped cap attached to a part of the outer surface of the nozzle body 1. The tangent to the inner surface of the nozzle head 2 and the plane of the nozzle outlet 9 form an outlet angle 12 of about 165°. The cross-sectional area of the outlet 5 of the inner flow channel is smaller than the cross-sectional area of the nozzle outlet 9. The inner channel 3 widens towards its end. In the example shown the inner channel is cylindrical with a constant diameter from the inlet 4 up to shortly before the outer channel 6 ends. From there on towards its outlet 5 the inner channel widens with a cone angle 13 of about 15°.

The outer flow channel 6 comprises two sections, a first section extending completely inside the nozzle body 1, and a second section 10 being formed by the outer surface of the nozzle body 1 and the inner surface of the nozzle head 2. The cross-sectional area of the outer flow channel 6 decreases in the direction of flow. The outer flow channel 6 of the nozzle comprises ten baffles 11 that extend in axial direction from the inlet 7 to the end of the first section, i.e. the outer flow channel inside the nozzle body 1 is entirely provided with baffles. In radial direction the baffles 11 extend from the inner wall to the outer wall of the outer flow channel 6. The baffles are uniformly distributed in the circumferential direction as can be seen from FIG. 3. The baffles 11 are helically shaped in the direction of flow so that they form a swirl region in the outer flow channel 6. Their inclination decreases with respect to the flow direction from the inlet 7 towards the outlet. The baffles 11 are integrally connected to the inner wall and the outer wall of the outer flow channel 6.

The cross-sectional areas of the inner flow channel 3 and of the outer flow channel 6 are—apart from the baffles 11—rotationally symmetrical. The cross-sectional area of the inner flow channel 3 is circular and the cross-sectional area of the outer flow channel 6 is a circular ring.

The embodiment shown of an atomizer nozzle shown in FIG. 1 through FIG. 3 can be produced by additive manufacturing techniques. The nozzle can be fabricated in one piece or in two pieces, i.e. the nozzle body 1 and the nozzle head 2 as separate pieces. In the latter case the nozzle body 1 and the nozzle head 2 can be made adjustable relative to one another in the axial direction, for example by providing threats on the outer side of the nozzle body and on the inner side of the nozzle head 2.

### EXAMPLE AND COMPARATIVE EXAMPLE

Experiments have been performed on a test bench to compare the performance of a conventional nozzle and a nozzle according to the invention. For the comparison, water was used as the first liquid fluid and air as the second gaseous fluid. In terms of viscosity and density water is comparable with many low viscosity fluid wastes.

The conventional nozzle was of the external mix type similar to the one disclosed in the document US 2017/0348721 A1. A straight inner channel with a circular cross-section for the liquid fluid was surrounded by a straight annular channel for the gaseous fluid. The annular channel comprised several fins at its outlet for swirl generation. The circular outlet of the inner channel and the annular outlet of the outer channel were located in the same plane perpendicular to the axes of the channels.

The nozzle according to the invention was designed like the example shown in FIGS. 1 to 3.

For the comparison of the two nozzles, the volumetric flow rate of the air stream was set to 200 Nm³/h (norm cubic meters per hour), which is a commonly used atomizing air flow rate in incineration processes. The volumetric water flow rate (in liter per hour) was set to three different values representing a low (350 l/h), medium (500 l/h) and a high (1000 l/h) throughput rate of fluid waste.

Visual inspections and photographs during the experiments showed that the spray pattern of the nozzle according to the invention was shorter and broader than that of the conventional nozzle in all three cases.

The atomization characteristics of the nozzle according to the invention was better in that the droplets formed during the atomization process were smaller in all three cases.

At the highest water flow rate of 1000 l/h, there was a significant increase in the droplet size in both nozzles. However, in the conventional nozzle the coarse droplets formed almost a continuous flow which would not be operable in an incineration process. The nozzle according to the invention in contrast produced droplets of a size that are still acceptable for an incineration process even at such extreme throughput rates.

1. An atomizer nozzle for atomizing a first fluid by means of a second fluid, comprising a nozzle body and a nozzle head, the atomizer nozzle having an inner flow channel arranged in the nozzle body with an inlet and an outlet for the first fluid to be atomized, and an outer flow channel arranged around the inner flow channel with an inlet and an outlet for the second fluid, the outlet of the inner flow channel ending before the outlet of the outer flow channel in the direction of flow, the outer flow channel at its outlet being inclined towards the inner flow channel, the nozzle head having a nozzle outlet for the atomized fluid and being placed on the outlet-side end of the nozzle body and partially surrounding it in the radial and in the axial direction, and the cross-sectional area of the outlet of the inner flow channel being smaller than the cross-sectional area of the nozzle outlet, characterized in that the nozzle head is designed as a sleeve-shaped cap attached to a part of the outer surface of the nozzle body, and that the outer flow channel comprises two sections, a first section extending completely in the nozzle body, and a second section being formed by the outer surface of the nozzle body and the inner surface of the nozzle head.

2. The atomizer nozzle according to claim 1, wherein the outer flow channel comprises baffles extending in axial direction over at least a partial area of the outer flow channel and in radial direction from the inner wall to the outer wall of the outer flow channel.

3. The atomizer nozzle according to claim 2, wherein the baffles are helically shaped in the direction of flow so that they form a swirl region in the outer flow channel.

4. The atomizer nozzle according to claim 2, wherein the inclination of the baffles decreases with respect to the flow direction from the inlet towards the outlet.

5. The atomizer nozzle according to claim 2, wherein the baffles are integrally connected to the inner wall and the outer wall of the outer flow channel.

6. The atomizer nozzle according to claim 2, wherein at least four baffles are present which are uniformly distributed in the circumferential direction.

7. The atomizer nozzle according to claim 1, wherein the tangent to the inner surface of the nozzle head and the plane of the nozzle outlet form an outlet angle of 100° to 180°.

8. The atomizer nozzle according to claim 1 wherein the cross-sectional area of the outer flow channel decreases in the direction of flow.

9. The atomizer nozzle according to claim 1, wherein the cross-sectional areas of the inner flow channel and of the outer flow channel are rotationally symmetrical.

10. The atomizer nozzle according to claim 9, wherein the cross-sectional area of the inner flow channel is circular and the cross-sectional area of the outer flow channel is a circular ring.

11. The atomizer nozzle according to claim 1, wherein the inner flow channel widens conically towards the end, the cone angle being in the range from 5° to 25°.

12. The atomizer nozzle according to claim 1, wherein the nozzle body and the nozzle head are adjustable relative to one another in the axial direction.

13. A waste incineration plant comprising at least one atomizer nozzle according to claim 1 for the incineration of waste.

14. A method for atomizing a first fluid by means of a second fluid, the method comprising using the atomizer nozzle according to claim 1, wherein the first fluid is a liquid and the second fluid is a gas.
